(19) United States
(12) Patent Application Publication
(10) Pub. No.: US 2025/0184854 A1
(43) Pub. Date: Jun. 5, 2025

(54) SYSTEMS AND METHODS FOR TIME-BASED TRIGGERED HANDOVER IN NON-TERRESTRIAL NETWORKS

(71) Applicant: TELEFONAKTIEBOLAGET LM ERICSSON (PUBL), Stockholm (SE)

(72) Inventors: Claes-Göran Persson, MJÖLBY (SE); Johan Rune, LIDINGÖ (SE)

(21) Appl. No.: 18/837,012

(22) PCT Filed: Feb. 10, 2023
(86) PCT No.: PCT/IB2023/051226

§ 371 Date: Aug. 8, 2024

Related U.S. Application Data
(60) Provisional application No. 63/309,433, filed on Feb. 11, 2022.

(51) Int. Cl. H04W 36/36; H04W 36/00

(52) U.S. Cl. CPC H04W 36/362; H04W 36/0079

(57) ABSTRACT

A method by a wireless device, configured for conditional handover to at least one candidate target cell, includes determining at least one of: a plurality of conditions associated with the conditional handover of the wireless device to the at least one candidate target cell has been fulfilled, at least one condition associated with the conditional handover of the wireless device to the at least one candidate target cell has not been fulfilled, an execution of the conditional handover to the at least one candidate target cell has failed within at least one time window associated with the at least one candidate target cell, and an execution of the conditional handover to the at least one candidate target cell succeeded within at least one time window associated with the at least one candidate target cell. Based on an outcome of the determining step and a configuration of the wireless device, the wireless device performs at least one action.

### TECHNICAL FIELD

The present disclosure relates, in general, to wireless communications and, more particularly, systems and methods for time-based triggered handover in Non-Terrestrial Networks (NTNs).

### BACKGROUND

In Third Generation Partnership Project (3GPP) Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since Release 13, Narrowband-Internet of Things (NB-IoT) and LTE-Machine Type Communication (LTE-M) are part of the LTE specifications and provide connectivity to massive machine type communications (mMTC) services.

In 3GPP Release 15, the first release of the 5th Generation System (5GS) was specified. This is a new generation radio access technology intended to serve use cases such as enhanced mobile broadband (eMBB), ultra-reliable and low latency communication (URLLC) and mMTC services. 5th Generation (5G) includes the New Radio (NR) access stratum interface and the 5G Core Network (5GC). The NR physical and higher layers are reusing parts of the LTE specification, and additional components are introduced when motivated by the new use cases.

In Release 15, 3GPP also started the work to prepare NR for operation in a Non-Terrestrial Network (NTN). The work was performed within the Study Item “NR to support Non-Terrestrial Networks” and resulted in 3GPP TR 38.811. In Release 16, the work to prepare NR for operation in a NTN continued with the Study Item “Solutions for NR to support Non-Terrestrial Network”. The Release 16 study item resulted in a Work Item RP-193234 being agreed for NR in Release 17, “Solutions for NR to support non-terrestrial networks (NTN)”.

### Satellite Communications

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite
Access link (or Service link) that refers to the link between a satellite and a User Equipment (UE).

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 1,500-35,786 km, with orbital periods ranging from 3-15 hours. MEO and LEO are also known as Non-Geo Synchronous Orbit (NGSO) type of satellite.
GEO: height at about 35,786 km, with an orbital period of 24 hours. Also known as a Geo Synchronous Orbit (GSO) type of satellite.

The significant orbit height means that satellite systems are characterized by a path loss that is significantly higher than what is expected in terrestrial networks. To overcome the pathloss it is often required that the access and feeder links are operated in line of sight conditions, and that the UE is equipped with an antenna offering high beam directivity.

A communication satellite typically generates several beams over a given area. The footprint of a beam is usually in an elliptic shape, which has been traditionally considered as a cell. The footprint of a beam is also often referred to as a spotbeam. The spotbeam may move over the earth surface with the satellite movement or may be earth fixed with some beam pointing mechanism used by the satellite to compensate for its motion. The size of a spotbeam depends on the system design, which may range from tens of kilometers to a few thousands of kilometers. FIG. 1 illustrates an example architecture of a satellite network with bent pipe transponders. The depicted architecture is also known as a transparent payload architecture.

As compared to the beams observed in a terrestrial network, NTN beams are very wide and cover an area outside of the area defined by the served cell. Beams covering adjacent cells will overlap and cause significant levels of intercell interference. To overcome the large levels of interference, a typical approach in NTN is to configure different cells with different carrier frequencies and polarization modes.

Three types of service links are supported in NTN:
Earth-fixed: provisioned by beam(s) continuously covering the same geographical areas all the time (e.g., in the case of GEO satellites).
Quasi-earth-fixed: provisioned by beam(s) covering one geographic area for a limited period and a different geographic area during another period (e.g., in the case of NGSO satellites generating steerable beams).
Earth-moving: provisioned by beam(s) whose coverage area slides over the earth surface (e.g., in the case of NGSO satellites generating fixed or non-steerable beams).

Herein, the terms beam and cell are used interchangeably, unless explicitly noted otherwise. Though certain embodiments may be focused on NTN, the methods proposed apply to any wireless network dominated by line of sight conditions.

### Connected State Mobility

In a connected state, which is referred to in the 3GPP specifications as the RRC_CONNECTED state, the UE has an active connection to the network for sending and receiving of data and signaling. In the connected state, mobility is controlled by the network to ensure connectivity is retained to the UE with no interruption or noticeable degradation of the provided service as the UE moves between the cells within the network. As requested by the network, the UE is required to search and perform measurements on neighbor cells both on the current carrier frequency (intra-frequency) as well as on other carrier frequencies (inter-frequency). The UE does not take any autonomous decisions with respect to when to trigger a handover to a neighbor cell (except to some extent when the UE is configured for Conditional Handover as discussed in more detail below). Instead, the UE sends the measurement results from the serving and neighboring cells to the network, and the network (i.e., a network node) makes a decision as to whether or not to perform a handover to one of the neighbor cells.

Connected state mobility is also known as handover. During the handover, the UE is moved from a source node using a source cell connection to a target node using a target cell connection. The target cell connection is associated with a target cell controlled by the target node. In other words, during a handover, the UE moves from the source cell to a target cell. The source node and the target node may also be referred to as the source access node and the target access node or the source radio network node and the target radio network node. In the 5G system, the source node and the target node are referred to as the source gNB and the target gNB.

In some cases, the source node and the target node are different nodes, such as different gNBs. These cases are also referred to as inter-node or inter-gNB handover.

In other cases, the source node and the target node are one and the same node, such as the same gNB. These cases are referred to as intra-node or intra-gNB handover and covers the case when the source and target cells are controlled by the same node.

In yet another case, handover is performed within the same cell and thus also within the same node controlling that cell. These cases are referred to as intra-cell handover.

It should also be understood that the source node (or source access node) and the target node (target access node) refer to a role served by a given access node during a handover of a specific UE. For example, a given access node may serve as source access node during handover of one UE, while it also serves as the target access node during handover of a different UE. And, in case of an intra-node or intra-cell handover of a given UE, the same access node serves both as the source access node and target access node for that UE.

An inter-node handover can further be classified as an Xn-based or NG-based handover depending on whether the source and target node communicate directly using the Xn interface or indirectly via the Core Network using the NG interface.

FIG. 2 illustrates a simplified signaling flow between the UE, the source gNB and the target gNB during an Xn-based inter-node handover in NR, as disclosed in Section 9.2.3.2.1 of TS 38.300 v. 15.13.0. It is noted that control plane data (i.e. Radio Resource Control (RRC) messages such as the measurement report, handover command and handover complete messages) are transmitted on Signaling Radio Bearers (SRBs), while the user plane data is transmitted on Data Radio Bearers (DRBs).

As depicted, the signaling may include one or more of the following:
Steps 1-2. The UE has an active connection to the source gNB where user data is sent and received to/from the network. Due to some trigger in the source gNB, e.g. a measurement report received from the UE, the source gNB decides to handover the UE to a target (neighbor) cell controlled by the target gNB.
Step 3. The source gNB sends the XnAP HANDOVER REQUEST message to the target gNB passing a transparent Radio Resource Control (RRC) container with necessary information to prepare the handover at the target side. The information includes for example the target cell id, the target security key, the current source configuration and UE capabilities.
Step 4. The target gNB prepares the handover and responds with the XnAP HANDOVER REQUEST ACKNOWLEDGE message to the source gNB, which includes the handover command (a RRCReconfiguration message containing the reconfigurationWithSync field) to be sent to the UE. The handover command includes configuration information that the UE should apply once it connects to the target cell, e.g., random access configuration, a new Cell Specific-Radio Network Temporary Identifier (C-RNTI) assigned by the target node, security parameters, etc.
Step 5. The source gNB triggers the handover by sending the handover command (received from the target gNB in the previous step) to the UE.
Step 6. Upon reception of the handover command, the UE releases the connection to the old (source) cell, starts the handover supervision timer T304, and starts to synchronize to the new (target) cell.
Steps 7-9. The source gNB stops scheduling any further downlink (DL) user data to the UE and sends the XnAP SN STATUS TRANSFER message to the target gNB, indicating the latest Packet Data Convergence Protocol (PDCP) Sequence Number (SN) transmitter and receiver status. The source gNB now also starts to forward DL user data received from the Core Network to the target gNB, which buffers this data for now.
Step 10. Once the UE has completed the random access procedure in the target cell, the UE stops the T304 timer and sends the handover complete message to the target gNB.
Step 11. Upon receiving the handover complete message, the target gNB starts sending (and receiving) user data to/from the UE. The target gNB requests the Core Network (CN) to switch the DL user data path between the User Plane Function (UPF) and the source node to the target node (communication to the CN is not shown in the FIG. 2). Once the path switch is completed, the target gNB sends the XnAP UE CONTEXT RELEASE message to the source gNB to release all resources associated to the UE.

### Conditional Handover (CHO)

In 3GPP Release 16, a new handover concept called Conditional Handover (CHO) was introduced in purpose to improve mobility robustness. CHO is addressing reliability issues in the handover procedure if e.g. the measurement report sent from the UE, or the handover command sent from the network to the UE, is lost due to quality issues with the radio link between the UE and the source node. This is typically the case when the handover is performed close to the cell edge.

To deal with this issue, CHO enables the network to transmit the handover command to the UE at an early stage when the quality of the radio link is still good, i.e. before the UE is getting close to the cell edge. The network configures the UE with one or more candidate target cells and with a CHO specific execution condition for each target cell. The CHO execution conditions are then evaluated by the UE and when fulfilled for one of the candidate target cells, the UE triggers a handover to that target cell.

The principle for CHO, as defined in 3GPP TS 38.300 Release 16, is described in FIGS. 3A-3B. Specifically, FIGS. 3A-3B illustrate an inter-gNB Conditional Handover in NR. The RRCReconfiguration message in step 6 is the Handover Command containing the CHO configuration(s). The method begins with the UE sending Measurement and Control Reports at step 1. Based on, for example, the Measurement Report received from the UE at step 1, the source gNB decides to configure the UE for CHO at step 2.

At step 3, the source node prepares one or potentially more candidate target nodes by including a CHO indicator and the current UE configuration in the HANDOVER REQUEST message sent over Xn. Unlike a regular (non-CHO) handover, CHO enables the network to prepare the UE with more than one candidate target cell. Each candidate target cell has its own target cell configuration (RRC Reconfiguration) and its own CHO execution condition. The target cell configuration is generated by the candidate target node, while the CHO execution condition is configured by the source node. For CHO in Release 16, the CHO execution condition may consist of one or two trigger conditions such as the A3 and A5 signal strength/quality based events defined in 3GPP TS 38.331.

As in a regular (non-CHO) handover, the handover command (RRCReconfiguration message) sent to the UE in step 6 is generated by the candidate target node but transmitted to the UE in the source cell by the source node. In case of an inter-node handover, as in FIGS. 3A-3B, the handover command is sent from the candidate target node to the source node within the Xn HANDOVER REQUEST ACKNOWLEDGE message at step 5 as a transparent container, meaning that the source node does not change the content of the handover command.

The target cell configuration (RRC Reconfiguration for the UE to use in the candidate target cell) and the CHO execution condition for each candidate target cell provided by the network to the UE is also known as the CHO configuration. The RRCReconfiguration message contains the CHO configuration(s). When received by the UE in the handover command (RRCReconfiguration message in step 6), the target cell configuration is not applied immediately as in a regular (non-CHO) handover. Instead the UE starts to evaluate the CHO execution condition(s) configured by the network.

The network may configure the UE with one or two trigger conditions (A3 and/or A5 event) per CHO execution condition and candidate target cell. If the UE is configured with two trigger conditions, then both events need to be fulfilled in order to trigger the CHO to the candidate target cell.

When the CHO execution condition is fulfilled for one of the candidate target cells, the UE detaches from the source cell, applies the associated target cell configuration (RRC Reconfiguration), and starts the handover supervision timer T304. At step 8, the UE then connects to the target gNB as in a regular handover. Any CHO configuration stored in the UE after completion of the RRC handover procedure is now released.

At step 8a, the target gNB sends the HANDOVER SUCCESS message over Xn to the source gNB to inform that the UE has successfully accessed the target cell. Triggering of data forwarding to the target gNB is typically done after receiving the HANDOVER SUCCESS message in the source gNB. This is also known as “late data forwarding.” As an alternative, data forwarding may be triggered at an earlier stage in the handover procedure such as after receiving the RRCReconfigurationComplete message from the UE, at step 7. This mechanism is also known as “early data forwarding.”

If more than one candidate target cell is configured to the UE during the Handover Preparation phase, then the source gNB needs to cancel the CHO for the candidate target cells not selected by the UE. The source gNB sends the HANDOVER CANCEL message over Xn towards the other signalling connection(s) or other candidate target node(s) to cancel the CHO and to initiate a release of the reserved resources in the target gNB(s), at step 8c.

During a regular (non-CHO) handover, if the handover attempt fails due to, for example, a radio link failure or an expiration of timer T304, the UE will typically perform a cell selection and continue with a re-establishment procedure. But when a CHO execution attempt fails and the selected cell is associated to a candidate target cell included in the CHO configuration, the UE will instead attempt a CHO execution to the selected target cell. This UE behaviour is, however, enabled/disabled by means of network configuration.

### CHO for NTN

Connected mode mobility challenges have been studied in the NTN Release 16 study item phase and are reported in 3GPP TR 38.821. Two of the challenges discussed in the Technical Report are frequent and unavoidable handovers such as, for example, due to feeder link switch and handover of a large number of UEs. Both could result in significant control plane overheads and frequent service interruptions. This issue is perhaps most pronounced in the quasi-earth-fixed cell scenario when a geographic area is covered by a satellite for a limited time period while being replaced by a new satellite during the next time period, and so on. When the satellite covering the geographic area is replaced, the cell is also replaced, meaning that all the UEs connected in the old cell have to be handed over to the new cell, which potentially results in a high control signaling peak because all of the handovers have to occur in conjunction with the cell replacement/switch. Hard and soft cell switch have been discussed. The preference is for the soft switch case in which the old and the new cell both (simultaneously) cover the geographic area during a short overlap period as this simplifies handovers and reduces interruptions.

To mitigate the expected signalling overhead at frequent handovers for a large number of UEs, 3GPP agreed to introduce support for Conditional Handover (CHO) for NTN in Release 17 with the CHO procedure and the trigger conditions as defined in Release 16 as a baseline.

In terrestrial networks, a UE can typically determine that the UE is near a cell edge due to a clear difference in received signal strength as compared to the cell center. The received signal strength may be determined by performing Reference Signal Received Power (RSRP) measurements. In NTN deployments, on the other hand, there is typically only a small difference in signal strength between the cell center and the cell edge. Thus, a UE may experience a small difference in signal strength between two beams (cells) in a region of overlap. This may lead to suboptimal UE behaviours such as repetitive handovers (“ping-pong”) between the two cells.

To avoid an overall reduction in handover robustness, 3GPP agreed to introduce the following trigger conditions (in addition to the already existing trigger conditions relating to the A3 and A5 events) for CHO in NTN:
A new time-based trigger condition, defining a time period, or a time window, when the UE may execute CHO to a candidate target cell.
A new location-based trigger condition, defining a distance threshold from the UE to the source cell and to a candidate target cell, based on which the UE may trigger and execute CHO.
Reuse of the existing A4 event (neighbour becomes better than threshold) as defined in 3GPP TS 38.331.
   It may be observed that only the handover mechanisms related to the time-based trigger condition are further discussed herein.

The time-based trigger condition is defined by 3GPP as the time period [t1, t2] associated to each candidate target cell, where t1 is the starting point of the time period represented by a Coordinated Universal Time (UTC), e.g. 00:00:01, and t2 is the end point of the time period represented by a time duration or a timer value, e.g. 10 seconds.

In a recent Change Request (CR) for NR NTN for 3GPP TS 38.331 in Release 17, the time-based condition (condEventT1-r17) is defined in ASN.1 in the ReportConfigNR IE as shown below:

| | |
|---|---|
| t1-Threshold-r17 | INTEGER (0..549755813887), |
| duration-r17 | INTEGER (ValueFFS) |
| } | |

The duration encoded by the duration-r17 field should be counted as starting from T1, which means that in principle T2=T1+duration=t1-Threshold-r17+duration-r17. RAN2 identified a value range 1 to 6000 in which each step represent 100 milliseconds. Thus, the value range of the duration-r17 field is 100 milliseconds up to 600 seconds.

3GPP further agreed that the time-based trigger condition can only be configured to the UE in combination with one of the signal strength/quality based events A3, A4 or A5. This implies that the UE may only perform CHO to the candidate target cell in the time window defined by T1 and T2 if the signal strength/quality based event is fulfilled within this time frame. The time-based trigger condition AND the signal strength/quality based trigger condition must thus be fulfilled simultaneously in order for the UE to execute the CHO.

It shall be noted that discussions are still ongoing in RAN2 as to whether a time-based trigger condition can be configured in combination with more than one signal strength/quality based trigger conditions and whether a time-based trigger condition can be configured in combination with a location-based trigger condition. If agreed to be supported in Release-17, it is assumed that both trigger conditions need to be fulfilled simultaneously in order for the UE to execute the CHO. Thus, if a time-based trigger condition and multiple signal strength/quality based trigger conditions are configured to the UE, or if a time-based trigger condition and a location-based trigger condition are configured to the UE, then all trigger conditions configured to the UE must be fulfilled simultaneously in order for the UE to execute the CHO.

The target cell configuration (RRCReconfiguration for the UE to use in the candidate target cell, i.e. the Handover Command, which is constructed by the candidate target node) and the CHO execution condition for each candidate target cell, provided by the network to the UE during the Handover Preparation phase, is known as the CHO configuration.

In 3GPP, discussions are still ongoing as to what the UE is supposed to do with the CHO configuration when the CHO execution condition has not been fulfilled (i.e. when CHO has not been triggered) for the candidate target cell at the time T2 expires.

There currently exist certain challenges that need to be addressed when evolving connected mode mobility solutions in NR to support NTN. For example, one issue is moving satellites, which result in moving or switching cells. The default assumption in terrestrial network design (e.g. NR or LTE) is that cells are stationary. This is not the case in NTN, especially when LEO satellites are considered. A LEO satellite may be visible to a UE on the ground only for a few seconds or minutes. There are two different options for LEO deployment. The beam/cell coverage is fixed with respect to a geographical location with quasi-earth-fixed beams, i.e. steerable beams from satellites ensure that a certain beam covers the same geographical area even as the satellite moves in relation to the surface of the earth. On the other hand, with moving beams, a LEO satellite has fixed antenna pointing direction in relation to the earth's surface such as, for example, perpendicular to the earth's surface. Thus, cell/beam coverage sweeps the earth as the satellite moves. In that case, the spotbeam, which is serving the UE, may switch every few seconds.
Another issue may be long propagation delays. Whereas, the propagation delays in terrestrial mobile systems are usually less than 1 millisecond, the propagation delays in NTN can be much longer, ranging from several milliseconds (LEO) to hundreds of milliseconds (GEO) depending on the altitudes of the spaceborne or airborne platforms deployed in the NTN.

Another complicating property of a NTN with quasi-earth-fixed cells is that when the responsibility for covering a certain geographical cell area switches from one satellite to another, preferably with a short period of overlap/coexistence (i.e. both the old and the new satellite cover the cell area simultaneously), this may be assumed to involve a cell change, which may include a change of PCI, which further means that all the UEs connected in the old cell (to/via the old satellite) have to be handed over to the new cell (and the new satellite) in a short time (i.e. the period of overlap/coexistence). This may cause a high load peak on the random access processing resources (including the RACH resources) and signaling and processing resources for handover preparation associated with the new cell. If these resources are overloaded, the consequences may involve, for example, extended interruption times, handover failures, and radio link failures.

Note also that even in the quasi-earth-fixed cells deployment case, potential handovers to neighbor cells other than the new cell that will take over the coverage of the same area as the current serving cell are possible and have to be taken into account, e.g. triggered by movements of the UE. These other neighbor cells also have limited service times, because of cell switches, where these cell switches may occur at different times.

### SUMMARY

Certain aspects of the disclosure and their embodiments may provide solutions to these or other challenges. According to certain embodiments, for example, methods and systems are provided for determining and/or indicating how the UE is to proceed when it is configured with one or more candidate target cell(s) and one or more of the candidate target cell(s) is (are) configured with a time-based CHO execution condition, and when the CHO execution condition for one or more of the candidate target cell(s) has (have) either been fulfilled or not fulfilled in the time window defined by T1 and T2.

According to certain embodiments, a method by a wireless device configured for CHO to at least one candidate target cell includes determining at least one of: a plurality of conditions associated with the conditional handover of the wireless device to the at least one candidate target cell has been fulfilled; at least one condition associated with the conditional handover of the wireless device to the at least one candidate target cell has not been fulfilled; an execution of the conditional handover to the at least one candidate target cell has failed within at least one time window associated with the at least one candidate target cell; and an execution of the conditional handover to the at least one candidate target cell succeeded within at least one time window associated with the at least one candidate target cell. Based on an outcome of the determining step and a configuration of the wireless device, the wireless device performs at least one action.

According to certain embodiments, a wireless device configured for CHO to at last one candidate target cell is adapted to determine at least one of: a plurality of conditions associated with the conditional handover of the wireless device to the at least one candidate target cell has been fulfilled; at least one condition associated with the conditional handover of the wireless device to the at least one candidate target cell has not been fulfilled; an execution of the conditional handover to the at least one candidate target cell has failed within at least one time window associated with the at least one candidate target cell; and an execution of the conditional handover to the at least one candidate target cell succeeded within at least one time window associated with the at least one candidate target cell. Based on an outcome of the determining step and a configuration of the wireless device, the wireless device is adapted to perform at least one action.

According to certain embodiments, a method by a network node operating as a source network node during a CHO of a wireless device to at least one candidate target cell includes transmitting, to the wireless device, at least one conditional handover configuration, which configures the wireless device to transmit information to the network node based on a determination by the wireless device of at least one of: at least one condition associated with the conditional handover of the wireless device to the at least one candidate target cell has not been fulfilled, and an execution of the conditional handover to the at least one candidate target cell has failed within at least one time window associated with the at least one candidate target cell.

According to certain embodiments, a network node operating as a source network node during a CHO of a wireless device to at least one candidate target cell is adapted to transmit, to the wireless device, at least one conditional handover configuration, which configures the wireless device to transmit information to the network node based on a determination by the wireless device of at least one of: at least one condition associated with the conditional handover of the wireless device to the at least one candidate target cell has not been fulfilled, and an execution of the conditional handover to the at least one candidate target cell has failed within at least one time window associated with the at least one candidate target cell.

Certain embodiments may provide one or more of the following technical advantage(s). For example, certain embodiments may provide a technical advantage of clarifying UE behavior when the UE is configured with one or more candidate target cells and the time-based CHO execution condition(s) for one or more candidate target cells has either been fulfilled or not fulfilled in the time window defined by T1 and T2. How to proceed in the different configuration scenarios will benefit the UE as well as the network since predictable UE behavior is essential for maintaining good performance and robustness in the network.

As another example, certain embodiments may provide a technical advantage of enabling the source node to know when a time-based CHO execution condition has not been fulfilled within the time window for a candidate target cell. Thus, the network may be informed if the UE did not perform CHO to the candidate target cell. By receiving this information, the source node may trigger the UE to perform a regular (non-CHO) handover to a neighbor cell. This information may be particularly important in a quasi-earth-fixed cell scenario where a geographic area is covered by a satellite (cell) for a short time period while being replaced by a new satellite (cell) during the next time period. When receiving the information that the CHO execution condition was not fulfilled, the source node may trigger the UE to perform a regular (non-CHO) handover to the new cell/satellite taking over the cell coverage area from the current serving (source) cell, or to perform a regular (non-CHO) handover to any adequate neighbor cell, which could serve as a target cell for the UE. Thus, certain embodiments may provide a technical advantage of avoiding a potential radio link failure in the source cell.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example architecture of a satellite network with bent pipe transponders;

FIG. 2 illustrates a signaling flow between the UE, the source gNB and the target gNB during an Xn-based inter-node handover in NR;

FIGS. 3A-3B illustrate an inter-gNB Conditional Handover in NR;

FIG. 4 illustrates an example communication system, according to certain embodiments;

FIG. 5 illustrates an example UE, according to certain embodiments;

FIG. 6 illustrates an example network node, according to certain embodiments;

FIG. 7 illustrates a block diagram of a host, according to certain embodiments;

FIG. 8 illustrates a virtualization environment in which functions implemented by some embodiments may be virtualized, according to certain embodiments;

FIG. 9 illustrates a host communicating via a network node with a UE over a partially wireless connection, according to certain embodiments;

FIG. 10 illustrates a method by a wireless device configured for CHO to at least one candidate target cell, according to certain embodiments; and

FIG. 11 illustrates a method by a network node operating as a source network node during a CHO of a wireless device to at least one candidate target cell, according to certain embodiments.

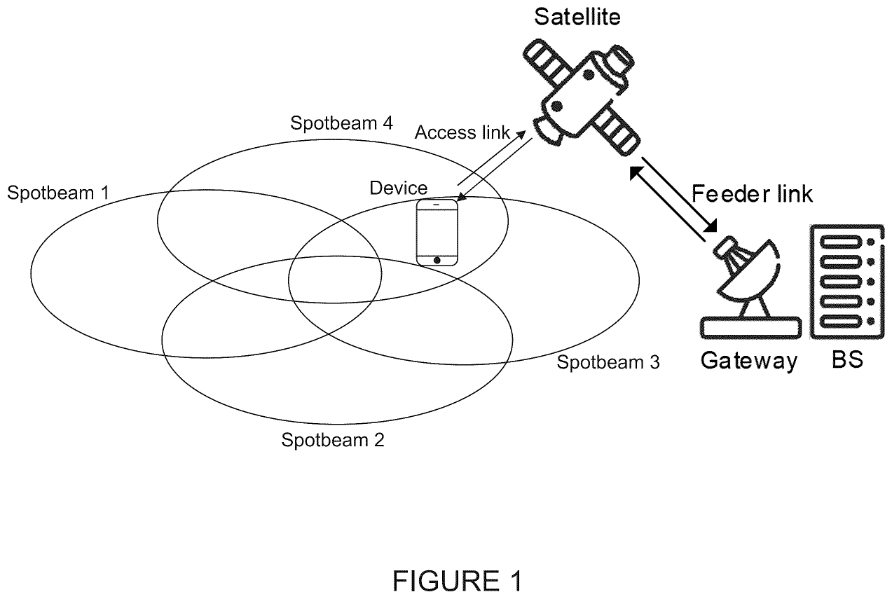

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

The embodiments outlined below are described mainly in terms of NR based (including IoT) NTNs, but they are equally applicable in a NTN based on LTE (including IoT) technology.

The term “network” is used in the solution description to refer to a network node, which typically will be an gNB (e.g. in a NR based NTN), but which may also be a eNB (e.g. in a LTE based NTN), or a base station or an access point in another type of network, or any other network node with the ability to directly or indirectly communicate with a UE.

The terms “source node”, “target node” and “candidate target node” are often used in the solution description. The “node” in these terms should be understood as typically being a RAN node in a NTN based on NR technology, LTE technology or any other RAT in which conditional handover or another conditional mobility concept is defined. In an NR based NTN, such a RAN node may be assumed to be a gNB. In an LTE based NTN (including an IoT NTN), such a RAN node may be assumed to be an eNB. Alternatives to, or refinements of, these interpretations are however also conceivable. For instance, a gNB may be an en-gNB, and if a split gNB architecture is applied (dividing the gNB into multiple separate entities or notes), the term “node” may refer to a part of the gNB, such as a gNB-CU (often referred to as just CU), a gNB-DU (often referred to as just DU), a gNB-CU-CP or a gNB-CU-UP. Similarly, an eNB may be an ng-eNB, and if a split eNB architecture is applied (dividing the gNB into multiple separate entities or notes), the term “node” may refer to a part of the eNB, such as an eNB-CU, an eNB-DU, an eNB-CU-CP or an eNB-CU-UP. Furthermore, the “node” in the terms may also refer to an IAB-donor, IAB-donor-CU, IAB-donor-DU, IAB-donor-CU-CP, or an IAB-donor-CU-UP.

When CHO is configured for a UE, a cell which the UE potentially can connect to (i.e. if the CHO execution condition is fulfilled for the cell) is denoted as “candidate target cell”. Similarly, a RAN node controlling a candidate target cell is denoted as “candidate target node”. However, once the UE has detected a fulfilled CHO execution condition for a candidate target cell, this terminology becomes a bit blurred. At this point, during the actual execution of the CHO and when the UE has connected to the new cell, the concerned cell may be referred to as either a “candidate target cell” or a “target cell”. Similarly, a RAN node controlling such a cell, may in this situation be referred to as either a “candidate target node” or a “target node”.

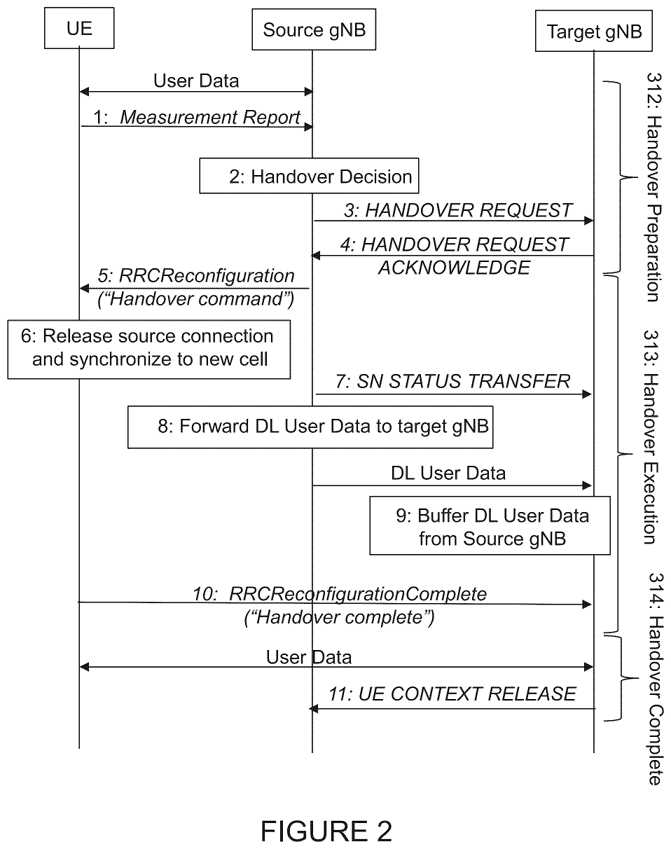

A condition included in a CHO configuration governing the execution of the conditionally configured procedure may be referred to as either a CHO execution condition or a HO execution condition. Similarly, as depicted in FIG. 2, phases of the procedure may be referred to as the Handover Preparation phase, the Handover Execution and/or the Handover Completion phase, or may be referred to as the Conditional Handover Preparation phase (or the (conditional) Handover Preparation phase), the Conditional Handover Execution phase and/or the Conditional Handover Completion phase.

When writing message names of a communication protocol, two equivalent principles are used in this document. The writing principle “<protocol name> <message name> message”, for example “XnAP HANDOVER CANCEL message”, and the writing principle “<message name> <protocol name> message”, for example “HANDOVER CANCEL XnAP message” are equivalent, both referring to a message (i.e. “<message name>”) of a communication protocol (i.e. “<protocol name>”), e.g. the HANDOVER CANCEL message of the communication protocol XnAP. The same writing format equivalence applies to other communication protocols, such as NGAP.

During the Handover Preparation phase, the source node sends an inter-node RRC message to the candidate target node, denoted as the HandoverPreparationInformation message. This inter-node RRC message contains the UE's configuration in the source cell, in particular the RRC related configuration. To convey the HandoverPreparationInformation message to a candidate target node, the source node includes it in the HANDOVER REQUEST XnAP message (in case of an Xn based CHO) or in a HANDOVER REQUIRED NGAP message (in case of an NG based CHO), and in case of an NG based CHO, the core network (represented by an AMF) will forward it to the candidate target node in the HANDOVER REQUEST NGAP message. In this document, the term “Handover Preparation message”, or “initial Handover Preparation message”, is often used. This term may refer to a HandoverPreparationInformation inter-node RRC message, or a HANDOVER REQUEST XnAP message (including the HandoverPreparationInformation inter-node RRC message) or a HANDOVER REQUIRED/HANDOVER REQUEST NGAP message (including the HandoverPreparationInformation inter-node RRC message).

When accessing a target cell during a HO or a CHO, the first message the UE sends to the target node in the target cell, after having sent a random access preamble and having received a Random Access Response message, is an RRCReconfigurationComplete message, indicating the successful completion of the HO or CHO. It should be noted that this RRCReconfigurationComplete message is often referred to as a Handover Complete message.

According to 3GPP agreements, a time-based CHO execution condition is always combined with a signal strength/quality CHO execution condition (both of which have to be fulfilled to trigger CHO execution). However, the proposed solutions disclosed herein do not assume that the UE always monitors a signal strength/quality condition (i.e. an A3, A4 or A5 event). The embodiments described herein are equally applicable when the UE is configured only with a time-based CHO execution condition. It may be noted, however, that in embodiments describing lack of trigger of the CHO execution within the time window (i.e. between T1 and T2), it may be assumed that a signal strength/quality condition is configured but not fulfilled between T1 and T2.

The term “Handover Preparation message” or “initial Handover Preparation message” may refer to a HandoverPreparationInformation inter-node RRC message, or a HANDOVER REQUEST XnAP message (including the HandoverPreparationInformation inter-node RRC message) or a HANDOVER REQUIRED|HANDOVER REQUEST NGAP message (including the HandoverPreparationInformation inter-node RRC message).

The terms “Handover Command” and “HandoverCommand” are used interchangeably herein. Both terms refer to a UE configuration the target node (of a regular handover) or candidate target node (of a conditional handover), during the (conditional) handover preparation phase, compiles for the UE to be subject to the handover or conditional handover. This UE configuration is compiled in the form of an RRCReconfiguration message, which is conveyed to the UE via the source node. The RRCReconfiguration message is associated with a certain target cell or candidate target cell and the UE applies the RRCReconfiguration when/if it accesses the concerned (candidate) target cell controlled by the (candidate) target node.

The terms “remaining serving time”, “remaining service time” and “remaining time to serve” all refer to the remaining time a cell will keep providing coverage in the present area. In 3GPP documents, it is also referred to as “Tservice”, “tservice”, “t-Service” or “t-Service-r17”. An alternative indication of when the cell will stop serving the area is the “serving cell stop time”, which is also a term that may be used in the solution description. This concept is applicable (mainly) for quasi-earth-fixed cells, which is also the deployment scenario the proposed solution mainly targets. For a quasi-earth-fixed cell, the concept may also be formulated as the time remaining until the cell disappears.

The time-based CHO trigger condition is defined by 3GPP as the time period [T1, T2] associated to each candidate target cell, where T1 is the starting point of the time period represented by a Coordinated Universal Time (UTC), e.g. 00:00:01, and T2 is the endpoint of the time period represented by a time duration or a timer value starting at T1, e.g. 10 seconds.

In the running Change Request (CR) for NR NTN for TS 38.331 Release 17, T1 and T2 are defined as the t1-Threshold-r17 and duration-r17 fields in the ReportConfigNR IE, sent to the UE in the RRCReconfiguration message during the (conditional) Handover Preparation phase. The duration encoded by the duration-r17 field should be counted as starting from T1, which means that in principle T2=T1+duration=t1-Threshold-r17+duration-r17.

The time period defined by T1 and T2 in which the UE may perform CHO to the candidate target cell is in this solution description often referred to as the “time window”. Furthermore, when it is mentioned that this time window is “active”, this means that T1 has occurred but T2 has not occurred, i.e. the current time is between T1 and T2.

The target cell configuration (RRCReconfiguration for the UE to use in the candidate target cell, i.e. the Handover Command, which is constructed by the candidate target node) and the CHO execution condition for each candidate target cell provided by the network to the UE is also known as the CHO configuration. The RRCReconfiguration message from the source/serving node conveying such a CHO configuration to the UE during the (conditional) Handover Preparation phase may contain a list of CHO configurations. Further CHO configurations may also subsequently be added to the list, and/or configured CHO configurations may be removed from the list, wherein RRCReconfiguration messages are used in both cases. Furthermore, the information provided from the source node to a candidate target node during the CHO preparation phase, i.e. in the HANDOVER REQUEST XnAP message or the HANDOVER REQUIRED and HANOVER REQUEST NGAP messages, e.g. the UE's source cell configuration (i.e. the UE context) and the indication that the prepared handover is conditional, is also referred to as a CHO configuration, albeit in the context of configuration information in a candidate target node.

As discussed above, CHO enables the network to prepare the UE with one or more candidate target cells, where each candidate target cell is configured with its own CHO execution condition. With the time-based CHO trigger condition introduced for NTN in 3GPP Release 17, each candidate target cell is configured with a time window in which the UE is allowed to perform CHO to the candidate target cell. The time window is defined by T1 and T2, where T1 represent the starting point of the time window, and T2 represent the end point of the time window. In the RRC specification, T1 is assumed to be represented as a UTC indication and T2 is assumed to be represented as a duration, starting at T1 and ending at T2. However, when a UE is configured with a time-based trigger condition, the UE may only perform CHO to the candidate target cell if the configured signal strength/quality based A3, A4 or A5 event is fulfilled in the time window defined by T1 and T2 (one of the signal strength/quality based events always need to be configured in combination with the time-based trigger condition).

The UE may be configured with a single candidate target cell or multiple candidate target cells, and each candidate target cell may have its own time window, which may fully overlap, partly overlap, or be fully separated in time with the time window(s) for the other candidate target cell(s)). As further noted above, a challenge with previous techniques and methods for CHO is that the UE does not know how to proceed in the different configuration scenarios. This results in unpredictable UE behavior, which may not only impact UE performance such as extended interruption times or radio link failures, but also the network performance in terms of increased signaling load.

Further, when the UE is configured with for, example, a single candidate target cell in a quasi-earth-fixed cell scenario and the configured signal strength/quality based A3, A4 or A5 event is not fulfilled (for whatever reason) in the time window defined by T1 and T2, the UE will not perform CHO to the candidate target cell but instead remain in the serving cell until the serving cell stops serving the geographical area in which the UE is located. When/if that happens, the UE will lose its connection to the network.

According to certain embodiments, the UE is configured with one or more candidate target cells where:
each candidate target cell is configured with a CHO execution condition consisting of a time-based trigger condition (i.e. each candidate target cell has its own time window) and one or more signal strength/quality based trigger conditions (A3, A4 or A5 event) or,
one or more candidate target cells are configured with a CHO execution condition consisting of a time-based trigger condition (i.e. each candidate target cell has its own time window) and a location-based trigger condition or,
one or more candidate target cells are configured with a CHO execution condition consisting of a time-based trigger condition (i.e. each candidate target cell has its own time window) and one or more signal strength/quality based trigger conditions (A3, A4 or A5 event), and one or more candidate target cells are configured with a CHO execution condition consisting of a “non-time-based” trigger condition, e.g. a location-based or one or more signal strength/quality based trigger conditions (A3, A4 or A5 event) or,
one or more candidate target cells are configured with a CHO execution condition consisting of a time-based trigger condition (i.e. each candidate target cell has its own time window) and a location-based trigger condition, and one or more candidate target cells are configured with a CHO execution condition consisting of a “non-time-based” trigger condition, e.g. a location-based or one or more signal strength/quality based trigger conditions (A3, A4 or A5 event.

The time windows configured to the UE for each candidate target cell may be fully overlapping in time, party overlapping in time or fully separated in time.

In a particular embodiment, the UE stops evaluating any other candidate target cell(s) when a CHO execution condition is fulfilled within the time window for one of the candidate target cells. The UE then performs CHO to the candidate target cell (as according to legacy CHO procedure defined in 3GPP Release 16) for which the CHO execution condition is fulfilled. If the triggered CHO execution fails, the UE may initiate connection re-establishment (in accordance with the procedures specified in 3GPP Release 16). In a variant of this embodiment, if the triggered CHO execution fails, the UE may only initiate connection re-establishment (in accordance with the procedures specified in 3GPP Release 16) to the associated candidate target cell if the time represented by T2 has not passed yet.

If, during the evaluation of the candidate target cells, multiple candidate target cells fulfill their respective CHO execution conditions before the UE has initiated a CHO execution, the decision which candidate target cell to select and to perform CHO towards is up to the UE implementation. As an example, the UE can consider the cell/beam quality or the remaining serving time of each of the candidate target cells for which the CHO execution conditions are fulfilled and then select and perform CHO to the candidate target cell with the best signal strength/signal quality or the candidate target cell with the longest remaining serving time. As an alternative, the decision which candidate target cell to select is configured by the network in, for example, the CHO configuration, which may, for example, associate a priority with each configured candidate target cell. The situation that multiple candidate target cells fulfill their respective CHO execution conditions before the UE has initiated a CHO execution may arise:
if the UE measures the signal strength/quality (for comparison with a signal strength/quality condition, e.g. in the form of a threshold, which is part of the overall CHO execution condition) of multiple candidate target cells using the same carrier frequency simultaneously, or
if the UE measures the signal strength/quality (for comparison with a signal strength/quality condition, e.g. in the form of a threshold, which is part of the overall CHO execution condition) of multiple candidate target cells on different carrier frequencies without evaluating the CHO execution conditions between the measurements on the different carrier frequencies, or
if the UE proceeds with further signal strength/quality measurement(s) (for comparison with a signal strength/quality condition, e.g. in the form of a threshold, which is part of the overall CHO execution condition), while evaluating CHO execution condition(s) based on already performed signal strength/quality measurement(s).

In another particular embodiment, the UE continues to evaluate the candidate target cell(s) for which the time window is still active (time represented by T2 has not passed yet) when a CHO execution condition is fulfilled within the time window for a candidate target cell. If the CHO execution succeeds for the candidate target cell for which the CHO execution condition is fulfilled, the UE may stop evaluating the other candidate target cells. If the CHO execution fails, the UE can continue evaluating the CHO execution condition for the other candidate target cells and thus the UE still has a chance to successfully execute the CHO to one of the configured candidate target cells. In one variant of this embodiment, the UE continuously evaluates the CHO execution conditions for the other candidate target cells while the UE attempts to execute the CHO to the candidate target cell for which the CHO execution condition has been fulfilled. In another variant of the embodiment, the UE stops evaluating the CHO execution conditions for the other candidate target cells when the CHO execution condition is fulfilled for one of the candidate target cells, but if the CHO execution to this candidate target cell fails, then the UE resumes the evaluation of the CHO execution conditions for the other candidate target cells (for which time has not reached T2 yet). In another embodiment, the UE continues to evaluate the other candidate target cell(s) for which the time window is still active, when a CHO execution condition is not fulfilled within the time window for a candidate target cell. The UE continues to evaluate the other candidate target cell(s) until a CHO execution condition is fulfilled for one of the candidate target cells or until the time window has expired for every configured candidate target cell. If a CHO execution condition is fulfilled, the UE performs CHO to that candidate target cell as according to the legacy CHO procedure.

In another particular embodiment, if T2 expires for a triggered CHO configuration (e.g. if the CHO execution condition is fulfilled for a candidate target cell but the UE fails to execute the CHO to the candidate target cell prior to T2 expiration, despite that the CHO execution condition was fulfilled before T2), the UE continues to monitor any other configured CHO execution condition. For example, the UE may continue to monitor a CHO configuration for another candidate target cell for which T2 has not expired yet or any “non-time-based” trigger condition such as, for example, a location-based or a signal strength/quality based trigger condition (A3, A4 or A5 event).

In another particular embodiment, if T2 expires for a non-triggered CHO configuration and there are other CHO configurations for which T1 has not occurred yet, or other CHO execution conditions configured to the UE consisting of one or more “non-time-based” trigger condition(s) (e.g. a location-based or a signal strength/quality based trigger condition (A3, A4 or A5 event)), the UE stays in RRC_CONNECTED state in the source cell and waits for T1 to occur for the other CHO configurations. The UE also continues to monitor the CHO execution condition of any other CHO configurations for which T1 has occurred but T2 has not expired, or any other CHO execution conditions consisting of one or more “non-time-based” trigger condition(s). If there is one or more other CHO configuration(s) for which the time window is active (i.e. T1 has occurred, but T2 has not occurred), the UE may monitor the CHO execution condition(s) of this/those CHO configuration(s) while waiting for T1 to occur for the CHO configurations for which T1 has not yet occurred. In a variant of this embodiment, the UE stays in RRC_CONNECTED state in the source cell and waits for T1 to occur for other CHO configurations, but it does not continue to monitor CHO configurations for which T1 has occurred (regardless of whether T2 has expired).

In another particular embodiment, if T2 expires for a triggered CHO configuration (i.e. the UE fails to execute the CHO to the candidate target cell prior to T2 expiration), despite that the CHO execution condition was fulfilled before T2, and there are other CHO configurations configured to the UE for which T1 has not occurred yet, or other CHO execution conditions consisting of one or more “non-time-based” trigger condition(s) (e.g. location-based or signal strength/quality based trigger condition(s) (A3, A4 or A5 event)), the UE stays in (or falls back to or returns to) RRC_CONNECTED state in the source cell and waits for T1 to occur for other CHO configurations, and the UE also continues to monitor any other CHO configurations for which T1 has occurred but T2 has not expired, or any other CHO execution conditions consisting of one or more “non-time-based” trigger condition(s). To enable this UE behavior, the UE has to be able to remain in (or fall back to or return to) RRC_CONNECTED state in the source cell, even though a CHO execution condition has been fulfilled. Therefore, the UE does not discard its source cell configuration immediately when the CHO execution condition is fulfilled but keeps it until successful CHO execution (including successful connection in the selected candidate target cell) is determined. In a variant of this embodiment, the UE stays in (or falls back to or returns to) RRC_CONNECTED state in the source cell and waits for T1 to occur for other CHO configurations, but it does not continue to monitor CHO configurations for which T1 has occurred (regardless of whether T2 has expired).

In yet another particular embodiment, the UE informs the source node when a CHO execution condition has not been fulfilled within the time window (i.e. when the time window expires) for a candidate target cell. The information that the CHO execution condition was not fulfilled, and that the UE thus did not perform a CHO to the candidate target cell, is sent to the source node as a new RRC message or as a new IE, or field, in an existing RRC message or as a MAC message such as, for example, in a new MAC CE. When the source node receives the information that the CHO execution condition was not fulfilled for a given candidate target cell such as, for example, in a quasi-earth-fixed cell scenario, the source node may use this information to trigger the UE to perform a regular (non-CHO) handover to the new cell/satellite taking over the cell coverage area from the current serving (source) cell (or to another suitable target cell if available). In this manner, a potential radio link failure in the source cell is avoided.

In a variant of this embodiment, the UE informs the source node when the CHO execution condition for the candidate target cell for which the time window ends last, represented by T2, is not fulfilled. That is, the UE informs the source node, when the time windows for all configured candidate target cells have expired without the CHO execution condition having been fulfilled for any of the candidate target cells (and note that this may include CHO configurations with non-overlapping (i.e. fully separated in time) time windows). As another option, the UE informs the source node, when the last T2 expires for a set of CHO configurations whose combined time windows (i.e. the union or envelope of the time windows of the CHO configurations in the set) form a continuous time period. As yet another option, the UE informs the source node for every T2 that expires.

In another variant of this embodiment, the UE keeps the CHO configuration after expiry of T2 for the candidate target cell for which the associated CHO execution condition was not fulfilled (i.e. the UE does not discard the CHO configuration at T2 when the time window expires). The UE informs the source node that the CHO execution condition was not fulfilled, and the source node may use this information to trigger the UE to perform a regular (non-CHO) handover to the candidate target cell (for which the associated CHO execution condition was not fulfilled) by referring to the CHO configuration stored by the UE. By re-using the CHO configuration kept by the UE, the source node does not need to request the target node to prepare the handover (i.e. to construct a handover command for the UE). Thus, the Handover Preparation phase may be much shorter as compared to a handover by previous methods and techniques.

In yet another variant of this embodiment, the UE also provides the network with the measurement result for the candidate target cell(s) configured to the UE, i.e. including the candidate target cell for which the CHO execution condition was not fulfilled. When the source node receives the information that the CHO execution condition was not fulfilled for a given candidate target cell together with the measurement result(s) for the candidate target cell(s), the source node may use this information to trigger the UE to perform a regular (non-CHO) handover to the new cell/satellite taking over the cell area from the current serving (source) cell, or to any adequate neighbor cell according to the received measurement result(s).

In another embodiment, the network configures the UE to inform the source node when a CHO execution condition has not been fulfilled within the time window (i.e. when the time window expires) for a candidate target cell, or if the CHO execution has failed for a candidate target cell. The configuration could be part of the CHO configuration, provided by the network to the UE in the RRCReconfiguration message sent during the Handover Preparation phase. As one variant, the network configures the UE to inform the source node for every candidate target cell for which the CHO execution condition was not fulfilled within the time window. As another variant, the network configures the UE to inform the source node that no CHO was executed, when the time windows of all the UE's stored CHO configurations have expired (and note that this may include CHO configurations with non-overlapping (i.e. fully separated in time) time windows). As yet another variant, the network configures the UE to inform the source node of not executed CHO when the last time window has expired for a set of CHO configurations whose combined time windows (i.e., the union or envelope of the time windows of the CHO configurations in the set) form a continuous time period.

In a variant of this embodiment, the UE knows from the type of serving cell or from information obtained in the serving cell such as, for example, from the “serving cell stop time” broadcasted in the serving cell, that the UE shall inform the source node when a CHO execution condition has not been fulfilled within the time window (i.e. when the time window expires) for a candidate target cell, or if the CHO execution has failed for a candidate target cell. The “serving cell stop time” is in the running CR for NTN aspects in TS 38.331 Release 17 defined as the time when the serving (source) cell in a quasi-earth-fixed cell scenario, stops serving the area it is currently covering. The “serving cell stop time”, in the running CR denoted as t-Service-r17, is proposed to be broadcasted in a new System Information Block in each quasi-earth-fixed cell in an NTN deployment.

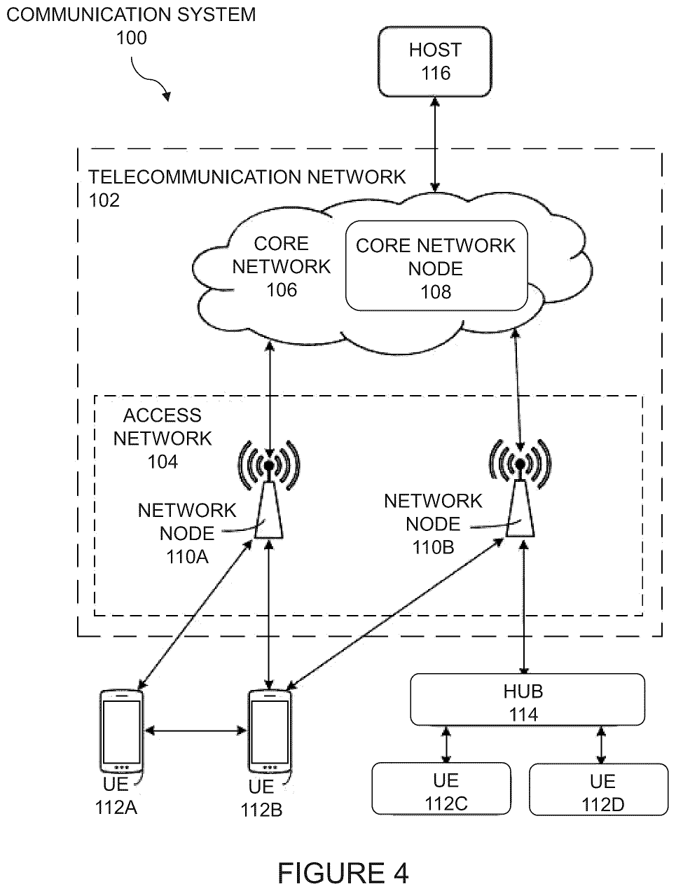

FIG. 4 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

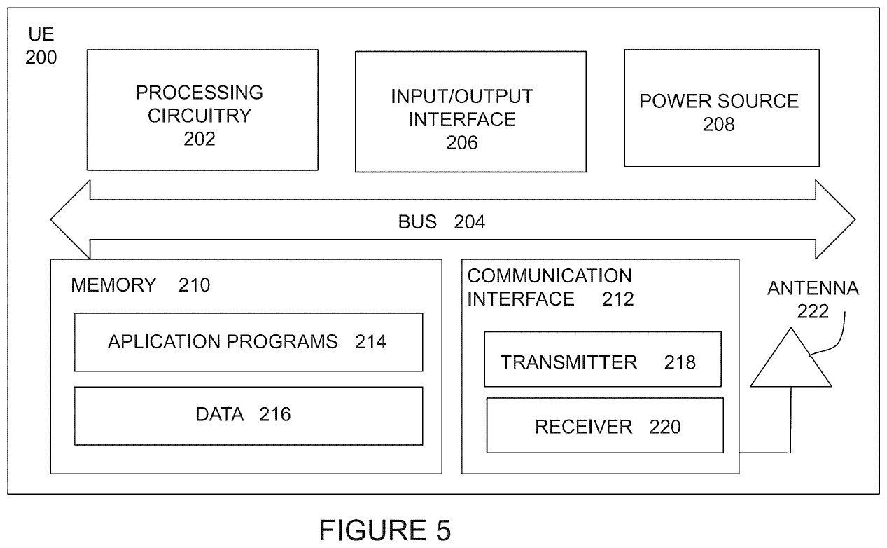

FIG. 5 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

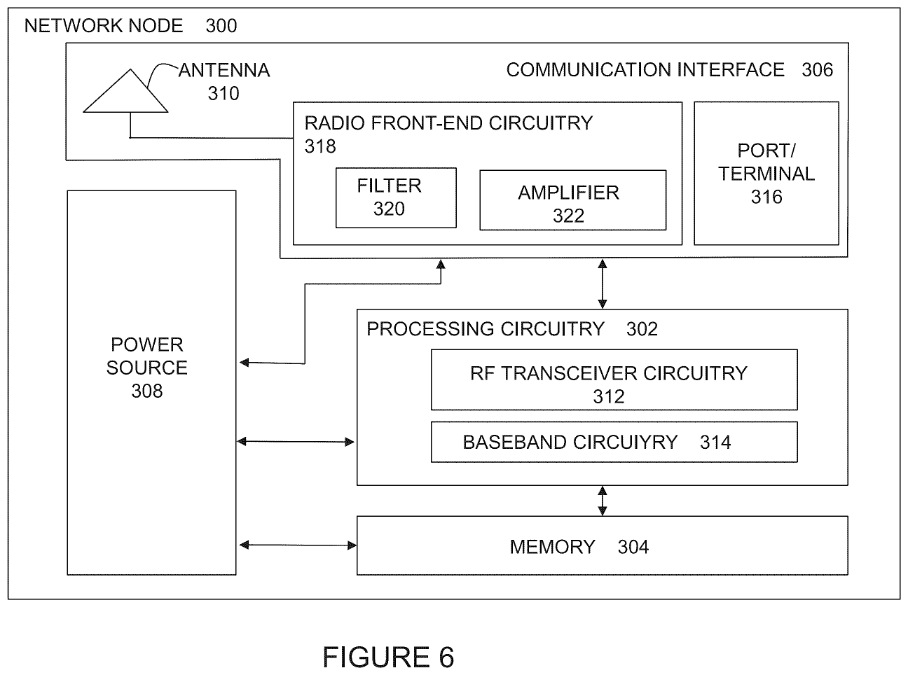

FIG. 6 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 6 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

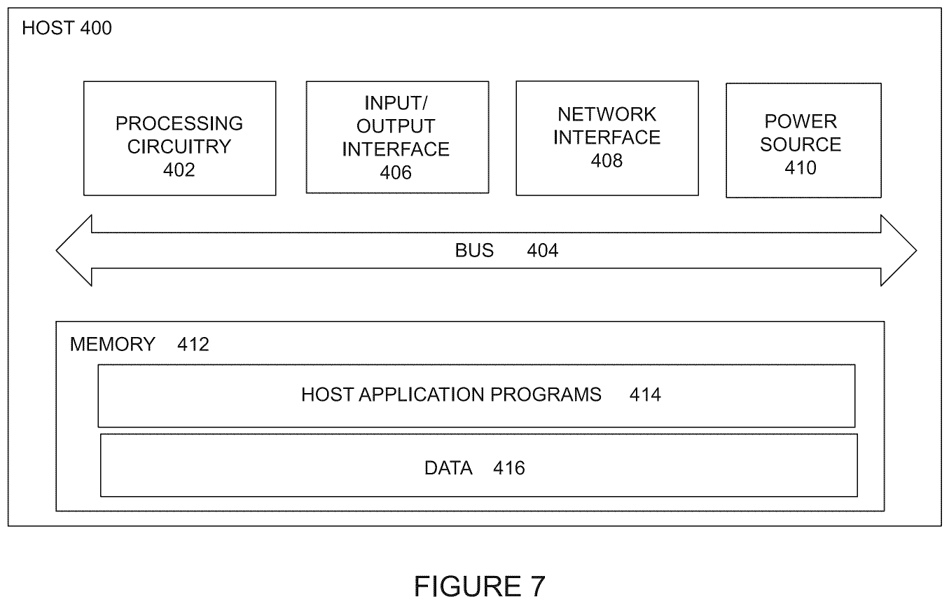

FIG. 7 is a block diagram of a host 400, which may be an embodiment of the host 116 of FIG. 4, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

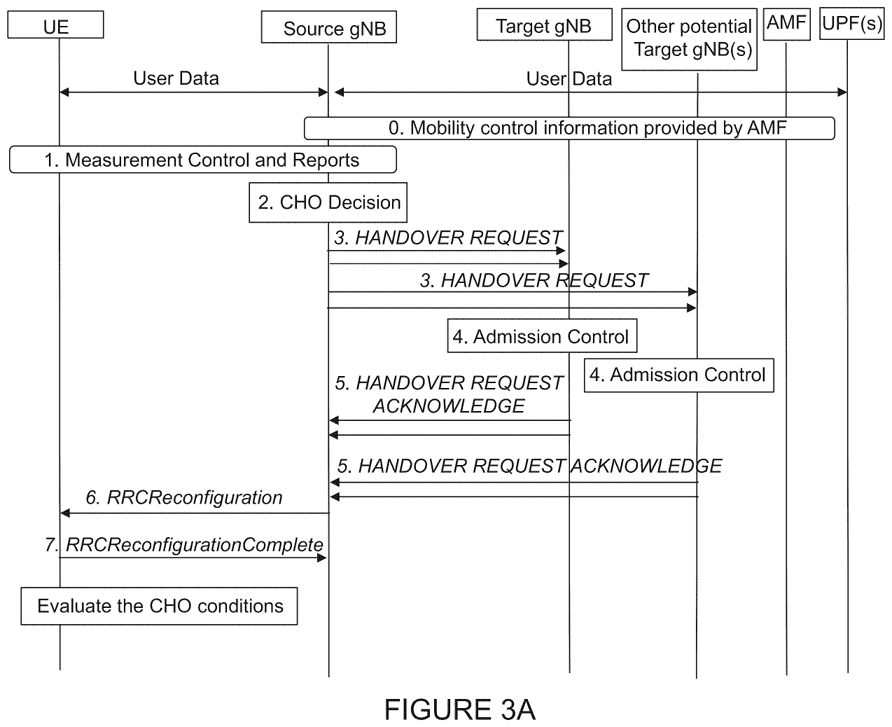

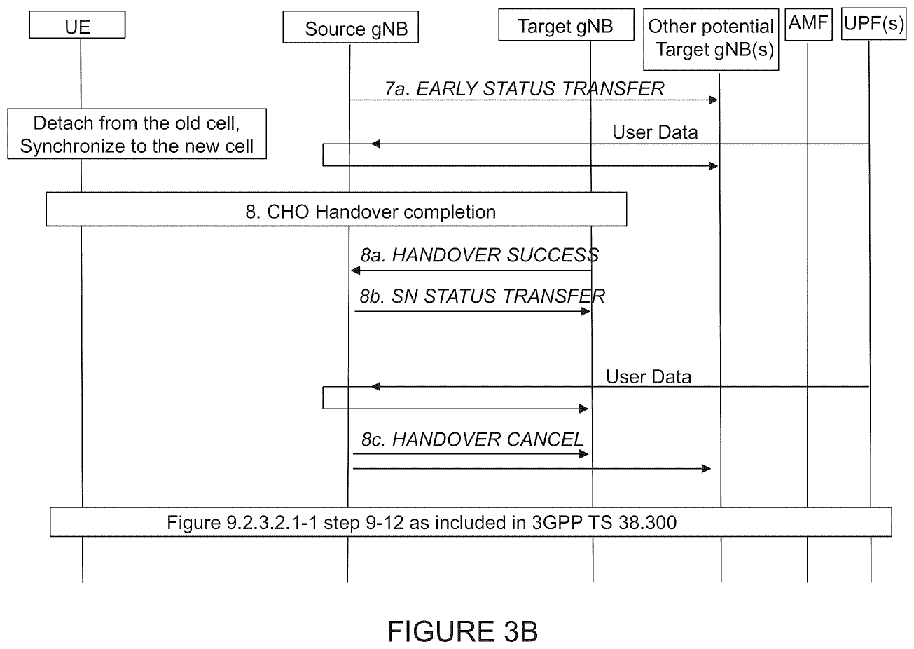

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

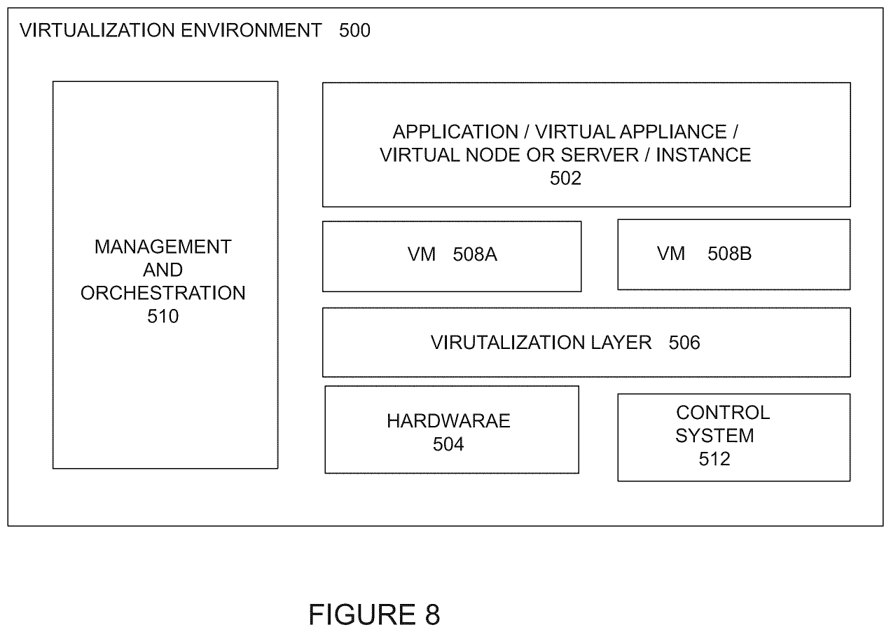

FIG. 8 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

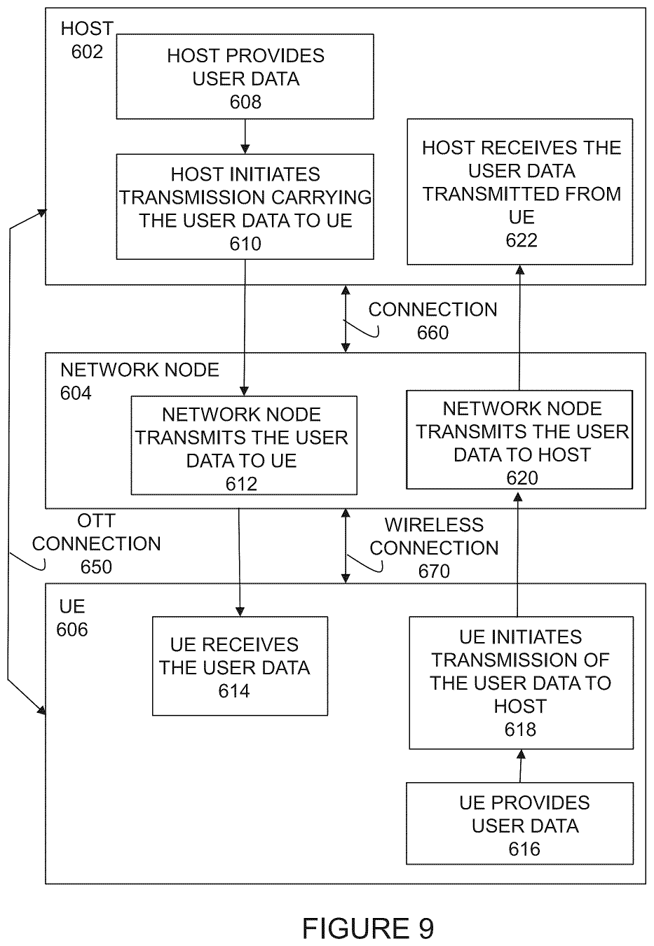

FIG. 9 shows a communication diagram of a host 602 communicating via a network node 604 with a UE 606 over a partially wireless connection in accordance with some embodiments.

Example implementations, in accordance with various embodiments, of the UE (such as a UE 112a of FIG. 4 and/or UE 200 of FIG. 5), network node (such as network node 110a of FIG. 4 and/or network node 300 of FIG. 6), and host (such as host 116 of FIG. 4 and/or host 400 of FIG. 7) discussed in the preceding paragraphs will now be described with reference to FIG. 9.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 4) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

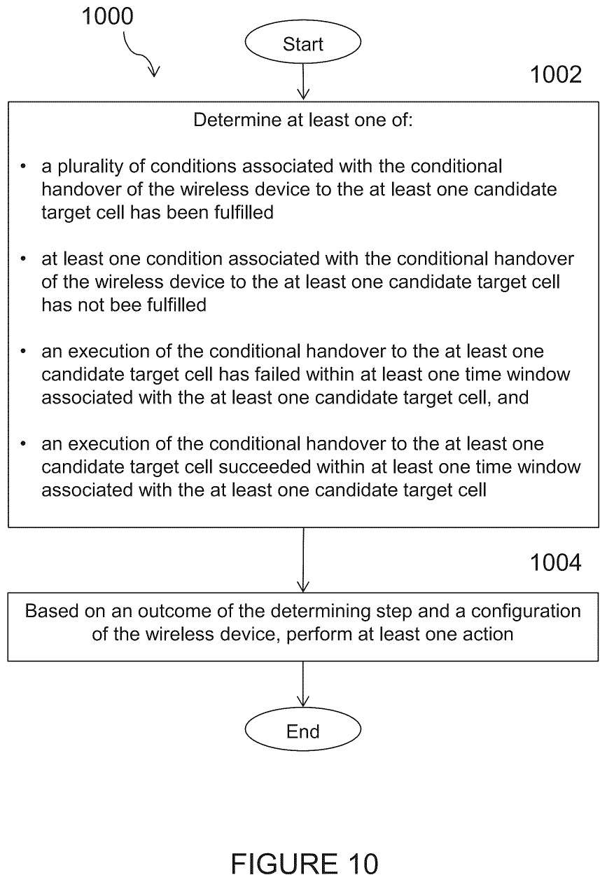

FIG. 10 illustrates a method 1000 by a wireless device 112 configured for CHO to at least one candidate target cell, according to certain embodiments. The method begins at step 1002 when the wireless device 112 determines at least one of: a plurality of conditions associated with the conditional handover of the wireless device to the at least one candidate target cell has been fulfilled; at least one condition associated with the conditional handover of the wireless device to the at least one candidate target cell has not been fulfilled; an execution of the conditional handover to the at least one candidate target cell has failed within at least one time window associated with the at least one candidate target cell; and an execution of the conditional handover to the at least one candidate target cell succeeded within at least one time window associated with the at least one candidate target cell. Based on an outcome of the determining step and a configuration of the wireless device, the wireless device 112 performs at least one action at step 1004.

In a particular embodiment, the plurality of conditions includes a time-based trigger condition associated with the at least one time window during which the conditional handover to the at least one candidate target cell can be performed and a signal strength or signal quality threshold to be met for the conditional handover to the at least one candidate target cell to be performed.

In a particular embodiment, the at least one time window is determined based on a starting point and a duration measured from the starting point.

In a particular embodiment, the wireless device 112 is configured with a plurality of candidate target cells, and each one of the candidate target cells is associated with one of a plurality of time windows.

In a particular embodiment, the wireless device 112 is configured with a plurality of candidate target cells, and at least two of the candidate target cells are associated with a same time window.

In a particular embodiment, the wireless device 112 determines that the plurality of conditions associated with the conditional handover of the wireless device 112 to the at least one candidate target cell has been fulfilled. When performing the at least one action, the wireless device ceases to monitor at least one other candidate target cell for a fulfillment of the at least one condition and/or attempts to execute the conditional handover of the wireless device to the at least one candidate target cell for which the plurality of conditions was fulfilled.

In a particular embodiment, the wireless device 112 determines that the attempt to execute the conditional handover of the wireless device 112 to the at least one candidate target cell has failed. The wireless device 112 initiates a connection re-establishment to the at least one candidate target cell when the time window has not expired for the at least one candidate target cell for which the attempt to execute the conditional handover failed.

In a particular embodiment, the wireless device 112 determines that the attempt to execute the conditional handover of the wireless device 112 to the at least one candidate target cell has failed and resumes or continues to monitor of at least one other candidate target cell for a fulfillment of at least one condition.

In a particular embodiment, the wireless device 112 transmits, to a network node 110, a message indicating that the attempt to execute the conditional handover of the wireless device to the at least one candidate target cell has failed.

In a particular embodiment, the wireless device 112 is configured with a plurality of candidate target cells, and the wireless device 112 determines that the plurality of conditions associated with the conditional handover have been fulfilled with respect to the plurality of the candidate target cells. When performing the at least one action the wireless device 112 selects a particular one of the plurality of candidate target cells and attempts to execute the conditional handover of the wireless device to the particular one of the plurality of candidate target cells.

In a further particular embodiment, when selecting the particular one of the plurality of candidate target cells, the wireless device 112 selects a best one of the plurality of candidate target cells based on at least one of: a signal strength or signal quality of each of the plurality of candidate target cells for which the plurality of conditions were fulfilled; a remaining serving time of each of the plurality of candidate target cells for which the plurality of conditions were fulfilled; and a priority level and/or priority value assigned to each of the plurality of candidate target cells for which the plurality of conditions were fulfilled.

In a particular embodiment, when performing the at least one action, the wireless device 112 transmits, to a network node 110, a message indicating that the time window has expired without the plurality of conditions having been fulfilled and/or without a successful execution of the conditional handover of the wireless device to the at least one candidate target cell.

In a particular embodiment, when performing the at least one action, the wireless device 112 transmits, to a network node 110, a message indicating that a time window for each of a plurality of candidate target cell has expired without the plurality of conditions having been fulfilled and/or without a successful execution of the conditional handover of the wireless device to any of the plurality of candidate target cells.

In a particular embodiment, the network node 110 comprises a source network node associated with a source cell, and the wireless device 112 transmits the message to the source network node based on a type of the source cell and/or information obtained in the serving cell.

In a particular embodiment, the information obtained in the serving cell comprises a serving cell stop time obtained from system information in the serving cell.

In a particular embodiment, the plurality of conditions are associated with at least a first conditional handover configuration associated with the at least one candidate target cell, and wherein performing the at least one action comprises at least one of: remaining in or returning to a connected state in a source cell; monitoring for a fulfillment of at least one condition associated with at least a second conditional handover configuration for which a time window has not expired; monitoring for a fulfillment of at least one non-time based condition associated with at least a third conditional handover configuration; and maintaining a conditional handover configuration after the time window for executing the conditional handover has passed and/or reusing the conditional handover configuration to execute a non-conditional handover to the at least one candidate target cell.

In a particular embodiment, when performing the at least one action, the wireless device 112 transmits, to a network node 110, a measurement result for the at least one candidate target cell.

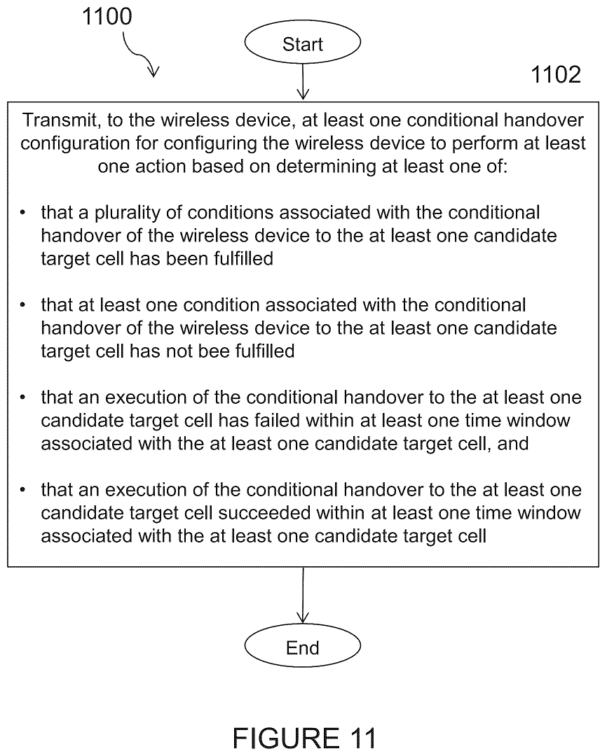

FIG. 11 illustrates a method 1100 by a network node 110 operating as a source network node during a CHO of a wireless device 112 to at least one candidate target cell, according to certain embodiments. The method begin at step 1102 when the network node 110 transmits, to the wireless device 112, at least one conditional handover configuration, which configures the wireless device to transmit information to the network node based on a determination by the wireless device 112 of at least one of: at least one condition associated with the conditional handover of the wireless device to the at least one candidate target cell has not been fulfilled, and an execution of the conditional handover to the at least one candidate target cell has failed within at least one time window associated with the at least one candidate target cell.

In a particular embodiment, the network node 110 receives, from the wireless device 112, information indicating at least one of: the at least one time window associated with the at least one candidate target cell has expired; all time windows associated with all of the candidate target cells has expired; at least one condition associated with the conditional handover of the wireless device to the at least one candidate target cell has not been fulfilled, the execution of the conditional handover to the at least one candidate target cell has failed within the at least one time window associated with the at least one candidate target cell, and the at least one action has been performed by the wireless device based on the at least one conditional handover configuration; and a measurement result for the at least one candidate target cell.

In a particular embodiment, the network node 110 configures the wireless device 112 to transmit a message based on a type of the source cell and/or based on a serving cell stop time transmitted from the serving cell to the wireless device 112. The message comprises the information indicating that the at least one time window associated with the at least one candidate target cell or that all time windows associated with all of the candidate target cells has expired.

In a particular embodiment, the plurality of conditions comprises: a time-based trigger condition associated with the at least one time window during which the conditional handover to the at least one candidate target cell can be performed; and a signal strength or signal quality threshold to be met for the conditional handover to the at least one candidate target cell to be performed.

In a particular embodiment, the at least one time window is determined based on a starting point and a duration measured from the starting point.

In a particular embodiment, the wireless device 112 is configured with a plurality of candidate target cells, and each one of the candidate target cells is associated with one of a plurality of time windows.

In a particular embodiment, the wireless device 112 is configured with a plurality of candidate target cells, and at least two of the candidate target cells are associated with a same time window.

In a particular embodiment, the at least one conditional handover configuration configures the wireless device to perform the following actions when the plurality of conditions associated with the conditional handover have been fulfilled with respect to the plurality of the candidate target cells:
select a particular one of the plurality of candidate target cells based on at least one of a signal strength or signal quality of each of the plurality of candidate target cells for which the plurality of conditions were fulfilled, a remaining serving time of each of the plurality of candidate target cells for which the plurality of conditions were fulfilled, and a priority level and/or priority value assigned to each of the plurality of candidate target cells for which the plurality of conditions were fulfilled, and
attempt to execute the conditional handover of the wireless device to the particular one of the plurality of candidate target cells.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) configured for conditional handover to a plurality of candidate target cells, the method comprising: determining at least one of: that at least one condition associated with the conditional handover of the wireless device to at least one of the plurality of candidate target cells has been fulfilled, that at least one condition associated with the conditional handover of the wireless device to at least one of the plurality of candidate target cells has not been fulfilled, that an execution of the conditional handover to at least one of the plurality of candidate target cells has failed within a time window, and that an execution of the conditional handover to at least one of the plurality of candidate target cells succeeded within a time window; and based on an outcome of the determining step and at least one rule stored at the wireless device and/or configuration of the wireless device, performing at least one action with respect to at least one other candidate target cell within the plurality of target cells.

Example Embodiment C2. The method of Example Embodiment C1, further comprising receiving a message indicating the at least one rule.

Example Embodiment C3. The method of any one of Example Embodiments C1 to C2, wherein: the wireless device determines that the at least one condition associated with the conditional handover of the wireless device to the at least one of the plurality of candidate target cells has been fulfilled, and performing the at least one action comprises: ceasing to monitor the at least one other candidate target cell for a fulfillment of the at least one condition, and attempting to execute the conditional handover of the wireless device to the at least one candidate target cell for which the condition was fulfilled.

Example Embodiment C4a. The method of Example Embodiment C3, further comprising: determining that the attempt to execute the conditional handover of the wireless device to the at least one candidate target cell has failed, and initiating a connection re-establishment to the at least one candidate target cell.

Example Embodiment C4b. The method of Example Embodiment C3, further comprising: determining that the attempt to execute the conditional handover of the wireless device to the at least one candidate target cell has failed, and resuming monitoring of the at least one other candidate target cell for a fulfillment of the at least one condition.

Example Embodiment C4c. The method of Example Embodiment C4b, further comprising remaining in a connected state.

Example Embodiment C4d. The method of any one of Example Embodiments C4a to C4c, further comprising transmitting, to a network node, a message indicating that the attempt to execute the conditional handover of the wireless device to the at least one candidate target cell has failed.

Example Embodiment C5. The method of any one of Example Embodiments C1 to C2, wherein: the wireless device determines that the at least one condition associated with the conditional handover has been fulfilled with respect to a plurality of the candidate target cells, and performing the at least one action comprises: selecting a particular one of the plurality of candidate target cells, and attempting to execute the conditional handover of the wireless device to the particular one of the plurality of candidate target cells.

Example Embodiment C6. The method of Example Embodiment C5, wherein selecting the particular one of the plurality of candidate target cells comprises selecting a best one of the plurality of candidate target cells based on at least one of: a cell quality or beam quality of each of the plurality of target cells for which the at least one condition was fulfilled; a remaining serving time of each of the plurality of target cells for which the at least one condition was fulfilled; and a priority level and/or priority value assigned to each of the plurality of target cells for which the at least one condition was fulfilled.

Example Embodiment C7. The method of any one of Example Embodiments C1 to C2, wherein: the wireless device determines that the at least one condition associated with the conditional handover of the wireless device to the at least one of the plurality of candidate target cells has been fulfilled, and performing the at least one action comprises: continuing to monitor the at least one other candidate target cell for a fulfillment of the at least one condition while attempting to execute the conditional handover of the wireless device to the at least one candidate target cell for which the condition was fulfilled.

Example Embodiment C8. The method of any one of Example Embodiments C1 to C7, wherein performing the at least one action comprises transmitting, to a network node, a message indicating that a time window for all candidate target cells has expired without the at least one condition having been fulfilled and/or without a successful execution of the conditional handover of the wireless device to any of the candidate target cells.

Example Embodiment C9. The method of any one of Example Embodiments C1 to C8, wherein performing the at least one action comprises maintaining a CHO configuration after a time window for executing the conditional handover has passed and/or reusing the CHO configuration to execute a non-CHO handover to at least one of the plurality of candidate target cells.

Example Embodiment C10. The method of any one of Example Embodiments C1 to C9, wherein performing the at least one action comprises transmitting, to a network node, a measurement result for at least one of the plurality of candidate target cells.

Example Embodiment C11. The method of Example Embodiments C1 to C10, further comprising: providing user data; and forwarding the user data to a host via the transmission to the network node.

Example Embodiment C12. A user equipment comprising processing circuitry configured to perform any of the methods of Example Embodiments C1 to C11.

Example Embodiment C13. A wireless device comprising processing circuitry configured to perform any of the methods of Example Embodiments C1 to C11.

Example Embodiment C14. A computer program comprising instructions which when executed on a computer perform any of the methods of Example Embodiments C1 to C11.

Example Embodiment C15. A computer program product comprising computer program, the computer program comprising instructions which when executed on a computer perform any of the methods of Example Embodiments C1 to C11.

Example Embodiment C16. A non-transitory computer readable medium storing instructions which when executed by a computer perform any of the methods of Example Embodiments C1 to C11.

### Group D Example Embodiments

Example Embodiment D1. A user equipment comprising: processing circuitry configured to perform any of the steps of any of the Group A and C Example Embodiments; and power supply circuitry configured to supply power to the processing circuitry.

Example Embodiment D2. A network node comprising: processing circuitry configured to perform any of the steps of any of the Group B Example Embodiments; power supply circuitry configured to supply power to the processing circuitry.

Example Embodiment D3. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment D4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment D5. The host of the previous Example Embodiment, wherein the cellular network further includes a network node configured to communicate with the UE to transmit the user data to the UE from the host.

Example Embodiment D6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment D7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment D8. The method of the previous Example Embodiment, further comprising: at the host, executing a host application associated with a client application executing on the UE to receive the user data from the UE.

Example Embodiment D9. The method of the previous Example Embodiment, further comprising: at the host, transmitting input data to the client application executing on the UE, the input data being provided by executing the host application, wherein the user data is provided by the client application in response to the input data from the host application.

Example Embodiment D10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment D11. The host of the previous Example Embodiment, wherein the cellular network further includes a network node configured to communicate with the UE to transmit the user data from the UE to the host.

Example Embodiment D12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment D13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment D14. The method of the previous Example Embodiment, further comprising: at the host, executing a host application associated with a client application executing on the UE to receive the user data from the UE.

Example Embodiment D15. The method of the previous Example Embodiment, further comprising: at the host, transmitting input data to the client application executing on the UE, the input data being provided by executing the host application, wherein the user data is provided by the client application in response to the input data from the host application.

Example Embodiment D16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B Example Embodiments to transmit the user data from the host to the UE.

Example Embodiment D17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment D18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B Example Embodiments to transmit the user data from the host to the UE.

Example Embodiment D19. The method of the previous Example Embodiment, further comprising, at the network node, transmitting the user data provided by the host for the UE.

Example Embodiment D20. The method of any of the previous 2 Example Embodiments, wherein the user data is provided at the host by executing a host application that interacts with a client application executing on the UE, the client application being associated with the host application.

Example Embodiment D21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B Example Embodiments to transmit the user data from the host to the UE.

Example Embodiment D22. The communication system of the previous Example Embodiment, further comprising: the network node; and/or the user equipment.

Example Embodiment D23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B Example Embodiments to receive the user data from a user equipment (UE) for the host.

Example Embodiment D24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment D25. The host of the any of the previous 2 Example Embodiments, wherein the initiating receipt of the user data comprises requesting the user data.

Example Embodiment D26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B Example Embodiments to receive the user data from the UE for the host.

Example Embodiment D27. The method of the previous Example Embodiment, further comprising at the network node, transmitting the received user data to the host.

1. A method by a wireless device, configured for conditional handover to at least one candidate target cell, the method comprising:
determining at least one of:
a plurality of conditions associated with the conditional handover of the wireless device to the at least one candidate target cell has been fulfilled,
at least one condition associated with the conditional handover of the wireless device to the at least one candidate target cell has not been fulfilled,
an execution of the conditional handover to the at least one candidate target cell has failed within at least one time window associated with the at least one candidate target cell, and
an execution of the conditional handover to the at least one candidate target cell succeeded within at least one time window associated with the at least one candidate target cell; and
based on an outcome of the determining step and a configuration of the wireless device, performing at least one action.

2. The method of claim 1, wherein the plurality of conditions comprises:
a time-based trigger condition associated with the at least one time window during which the conditional handover to the at least one candidate target cell can be performed; and
a signal strength or signal quality threshold to be met for the conditional handover to the at least one candidate target cell to be performed.

3. (canceled)

4. The method of claim 1, wherein the wireless device is configured with a plurality of candidate target cells, and wherein each one of the candidate target cells is associated with one of a plurality of time windows.

5. The method of claim 1, wherein the wireless device is configured with a plurality of candidate target cells, and wherein at least two of the candidate target cells are associated with a same time window.

6. The method of claim 1, wherein:
the wireless device determines that the plurality of conditions associated with the conditional handover of the wireless device to the at least one candidate target cell has been fulfilled, and
performing the at least one action comprises:
ceasing to monitor at least one other candidate target cell for a fulfillment of the at least one condition, and/or
attempting to execute the conditional handover of the wireless device to the at least one candidate target cell for which the plurality of conditions was fulfilled.

7. The method of claim 6, further comprising:
determining that the attempt to execute the conditional handover of the wireless device to the at least one candidate target cell has failed, and
initiating a connection re-establishment to the at least one candidate target cell when the time window has not expired for the at least one candidate target cell for which the attempt to execute the conditional handover failed.

8. The method of claim 6, further comprising:
determining that the attempt to execute the conditional handover of the wireless device to the at least one candidate target cell has failed, and
resuming or continuing to monitor of at least one other candidate target cell for a fulfillment of at least one condition.

9. The method of claim 6, further comprising transmitting, to a network node, a message indicating that the attempt to execute the conditional handover of the wireless device to the at least one candidate target cell has failed.

10.-13. (canceled)

14. The method of claim 9, wherein the network node comprises a source network node associated with a source cell, and wherein the wireless device transmits the message to the source network node based on a type of the source cell and/or information obtained in the serving cell wherein the information obtained in the serving cell comprises a serving cell stop time obtained from system information in the serving cell.

15. (canceled)

16. The method of claim 1, wherein the plurality of conditions are associated with at least a first conditional handover configuration associated with the at least one candidate target cell, and wherein performing the at least one action comprises at least one of:
remaining in or returning to a connected state in a source cell;
monitoring for a fulfillment of at least one condition associated with at least a second conditional handover configuration for which a time window has not expired;
monitoring for a fulfillment of at least one non-time based condition associated with at least a third conditional handover configuration; and
maintaining a conditional handover configuration after the time window for executing the conditional handover has passed and/or reusing the conditional handover configuration to execute a non-conditional handover to the at least one candidate target cell.

17. (canceled)

18. A method by a network node operating as a source network node during a conditional handover of a wireless device to at least one candidate target cell, the method comprising:
transmitting, to the wireless device, at least one conditional handover configuration for configuring the wireless device to transmit information to the network node based on determining by the wireless device at least one of:
at least one condition associated with the conditional handover of the wireless device to the at least one candidate target cell has not been fulfilled, and
an execution of the conditional handover to the at least one candidate target cell has failed within at least one time window associated with the at least one candidate target cell.

19. The method of claim 18, comprising receiving, from the wireless device, information indicating at least one of:
the at least one time window associated with the at least one candidate target cell has expired;
all time windows associated with all of the candidate target cells has expired;
at least one condition associated with the conditional handover of the wireless device to the at least one candidate target cell has not been fulfilled,
the execution of the conditional handover to the at least one candidate target cell has failed within the at least one time window associated with the at least one candidate target cell, and
the at least one action has been performed by the wireless device based on the at least one conditional handover configuration; and
a measurement result for the at least one candidate target cell.

20. The method of claim 19, comprising:
configuring the wireless device to transmit a message based on a type of the source cell and/or based on a serving cell stop time transmitted from the serving cell to the wireless device, and
wherein the message comprises the information indicating that the at least one time window associated with the at least one candidate target cell or that all time windows associated with all of the candidate target cells has expired.

21. The method of claim 18, wherein the plurality of conditions comprises:
a time-based trigger condition associated with the at least one time window during which the conditional handover to the at least one candidate target cell can be performed; and
a signal strength or signal quality threshold to be met for the conditional handover to the at least one candidate target cell to be performed.

22. (canceled)

23. The method of claim 18, wherein the wireless device is configured with a plurality of candidate target cells, and wherein each one of the candidate target cells is associated with one of a plurality of time windows.

24. The method of claim 18, wherein the wireless device is configured with a plurality of candidate target cells, and wherein at least two of the candidate target cells are associated with a same time window.

25. The method of claim 18, wherein the at least one conditional handover configuration configures the wireless device to perform the following actions
when the plurality of conditions associated with the conditional handover have been fulfilled with respect to the plurality of the candidate target cells:
select a particular one of the plurality of candidate target cells based on at least one of:
a signal strength or signal quality of each of the plurality of candidate target cells for which the plurality of conditions were fulfilled;
a remaining serving time of each of the plurality of candidate target cells for which the plurality of conditions were fulfilled; and
a priority level and/or priority value assigned to each of the plurality of candidate target cells for which the plurality of conditions were fulfilled, and
attempt to execute the conditional handover of the wireless device to the particular one of the plurality of candidate target cells.

26. A wireless device, configured for conditional handover to at least one candidate target cell, the wireless device adapted to:
determining at least one of:
a plurality of conditions associated with the conditional handover of the wireless device to the at least one candidate target cell has been fulfilled,
at least one condition associated with the conditional handover of the wireless device to the at least one candidate target cell has not been fulfilled,
an execution of the conditional handover to the at least one candidate target cell has failed within at least one time window associated with the at least one candidate target cell, and
an execution of the conditional handover to the at least one candidate target cell succeeded within at least one time window associated with the at least one candidate target cell; and
based on an outcome of the determining step and a configuration of the wireless device, performing at least one action.

27.-28. (canceled)

29. The wireless device of claim 26, wherein the wireless device is configured with a plurality of candidate target cells, and wherein each one of the candidate target cells is associated with one of a plurality of time windows.

30. The wireless device of claim 26, wherein the wireless device is configured with a plurality of candidate target cells, and wherein at least two of the candidate target cells are associated with a same time window.

31. The wireless device of claim 26, wherein:
the wireless device determines that the plurality of conditions associated with the conditional handover of the wireless device to the at least one candidate target cell has been fulfilled, and
when performing the at least one action, the wireless device is adapted to:
cease to monitor at least one other candidate target cell for a fulfillment of the at least one condition, and/or
attempt to execute the conditional handover of the wireless device to the at least one candidate target cell for which the plurality of conditions was fulfilled.

32. The wireless device of claim 31, wherein the wireless device is adapted to:
determine that the attempt to execute the conditional handover of the wireless device to the at least one candidate target cell has failed, and
perform at least one of:
initiate a connection re-establishment to the at least one candidate target cell when the time window has not expired for the at least one candidate target cell for which the attempt to execute the conditional handover failed; and
resume or continue to monitor of at least one other candidate target cell for a fulfillment of at least one condition.

33.-34. (canceled)

35. The wireless device of claim 26, wherein when performing the at least one action, the wireless device is configured to transmit at least one message to a network node, the at least one message indicating at least one of:
the time window has expired without the plurality of conditions having been fulfilled and/or without a successful execution of the conditional handover of the wireless device to the at least one candidate target cell;
the time window for each of a plurality of candidate target cell has expired without the plurality of conditions having been fulfilled and/or without a successful execution of the conditional handover of the wireless device to any of the plurality of candidate target cells; and
a measurement result for the at least one candidate target cell.

36. The wireless device of claim 35, wherein the network node comprises a source network node associated with a source cell, and wherein the wireless device is adapted to transmit the at least one message to the source network node based on a type of the source cell and/or a serving cell stop time obtained from system information in the serving cell.

37. The wireless device of claim 26, wherein the plurality of conditions are associated with at least a first conditional handover configuration associated with the at least one candidate target cell, and wherein when performing the at least one action the wireless device is adapted to perform at least one of:
remaining in or returning to a connected state in a source cell;
monitoring for a fulfillment of at least one condition associated with at least a second conditional handover configuration for which a time window has not expired;
monitoring for a fulfillment of at least one non-time based condition associated with at least a third conditional handover configuration; and
maintaining a conditional handover configuration after the time window for executing the conditional handover has passed and/or reusing the conditional handover configuration to execute a non-conditional handover to the at least one candidate target cell.

38.-45. (canceled)
